(19) United States
(12) Patent Application Publication
(10) Pub. No.: US 2010/0218683 A1
(43) Pub. Date: Sep. 2, 2010

(54) GAS DETECTING APPARATUS AND AIR PURIFICATION SYSTEM

(75) Inventors: Tae-Yun Chung, Gangwon-do (KR); Seung-Chul Ha, Gyeonggi-do (KR); Pan-Jong Park, Gangwon-do (KR)

Correspondence Address: THE NATH LAW GROUP, 112 South West Street, Alexandria, VA, 22314, US

(73) Assignees: KANGNUNG NATIONAL UNIVERSITY INDUSTRIAL ACADEMY CORPORATION GROUP, Gangwon-do (KR); SENKO CO. LTD., Gangwon-do (KR)

(21) Appl. No.: 12/161,690

(22) PCT Filed: Jan. 17, 2007
(86) PCT No.: PCT/KR07/00278

§ 371 Date: Jul. 30, 2008

(30) Foreign Application Priority Data
Jan. 20, 2006 (KR) 10-2006-0006435

(51) Int. Cl. B01D 46/46; G08B 17/10

(52) U.S. Cl. 96/399; 340/632; 96/417

(57) ABSTRACT

Provided are an indoor gas detecting apparatus and an indoor air purification system. The indoor gas detecting apparatus includes: a gas sensor unit composed of a plurality of gas sensors and a fine dust sensor; a controller controlling overall operations; a display unit; an alarm unit; and a communication unit transmitting/receiving data to/from an external apparatus. If a detected gas amount exceeds a predetermined permission level of each gas, the controller transmits an operation signal to an external automatic gas blocking apparatus or an external air purification apparatus so as to operate the automatic gas blocking apparatus or the air purification apparatus. Accordingly, not only fresh indoor air can be maintained but also an explosion or a fire can be prevented.

### CROSS-REFERENCE TO RELATED APPLICATIONS

This is a US national stage of International Application PCT/KR2007/000278, filed Jan. 17, 2007, and claims the benefit of priority of Republic of Korea patent application number 10-2006-0006435, filed Jan. 20, 2006, both of which are incorporated by reference herein in their entireties.

### INTRODUCTION

The present invention relates to an indoor gas detecting apparatus, and more particularly, to an indoor gas detecting apparatus, which detects a noxious gas contained in the air of an indoor environment such as home or office and informs a user of information on the detection result or transmits the information to external apparatuses so as to purify the indoor air, and an indoor air purification system using the indoor air detecting apparatus.

### BACKGROUND

In general, an air purification system is installed at home or office to eliminate impurities contained in indoor air, such as various dusts, noxious gases, and filthy odors, so as to provide an indoor environment with fresh air. However, there is a significant limit in the type of gases that can be detected by the air purification system.

In addition, the conventional air purification system cannot operate in conjunction with an automatic gas blocking apparatus. Therefore, even if the air purification system detects gas that is leaked from a gas range or a gas boiler, the gas cannot be protected against leakage.

Accordingly, the present invention proposes a concept in which various types of noxious gases are detected and the detection result is provided to a home network system or a home security system so that the indoor environment can be maintained to be pleasant and secure.

### SUMMARY

The present invention provides an indoor gas detecting apparatus which detects various types of noxious gases and fine dusts contained in indoor air, and, if the detected amount of the gases or fine dusts exceeds a permission level, informs the detection result.

The present invention also provides an indoor air purification system which maintains the indoor air to be fresh and secure by using the indoor gas detecting apparatus in conjunction with respective apparatuses of a home network system.

According to an aspect of the present invention, there is provided an indoor gas detecting apparatus comprising: a gas sensor unit composed of one or more gas sensors; a controller that controls overall operations; a display unit that displays data received from the controller; an alarm unit that operates in response to a control signal of the controller; a memory that stores and manages information sensed by the gas sensor unit or a predetermined permission level for each gas; and a communication unit that transmits data transmitted from the controller to an external apparatus or transmits data received from the external apparatus to the controller; wherein the controller receives a signal for each gas from the gas sensor unit, detects a gas amount by using the received signal, and, if the detected gas amount exceeds the predetermined permission level, displays the gas amount to the display unit or transmits the gas amount to the external apparatus through the communication unit.

In the aforementioned aspect of the present invention, the gas sensor unit may be composed of: a first gas sensor unit that includes one or more sensors selected from the group consisting of ozone sensor, a formaldehyde sensor, a carbon monoxide sensor, and a nitrogen dioxide sensor; a second gas sensor unit that includes one or more sensors selected from the group consisting of a volatile organic compound sensor, a fine dust sensor, and a carbon dioxide sensor; and a third gas sensor unit that includes one or more sensors selected from the group consisting of a liquefied natural sensor and a liquefied petroleum gas sensor.

In addition, the controller may detect a gas concentration input from the fuel liquefied gas sensor, and if the detected gas concentration exceeds the predetermined permission level, may display the gas amount to the display unit or transmits an operation signal to an external automatic gas blocking apparatus and/or a ventilation fan through the communication unit.

According to another aspect of the present invention, there is provided an indoor air purification system comprising: an indoor gas detecting apparatus which has one or more gas sensors and a communication module transmitting/receiving data to/from an external apparatus, detects concentration of a specific gas contained in indoor air, and transmits relevant information to the external apparatus; an air purification apparatus which has a communication module transmitting/receiving data to/from the indoor gas detecting apparatus and operates in response to an operation request signal transmitted from the indoor gas detecting apparatus; and an automatic gas blocking apparatus which has a communication module capable of data communication with the indoor gas detecting apparatus and operates in response to the operation request signal transmitted from the indoor gas detecting apparatus.

According to the present invention, noxious gases and fine dusts contained in indoor air can be detected, and the detection result can be immediately informed to a user if the detection result exceeds a permission level.

In addition, an indoor gas detecting apparatus of the present invention allows an air purification apparatus and an automatic air blocking apparatus to operate in conjunction with a home networking system or a home security system. Therefore, fresh indoor air can be maintained. Moreover, since gas leakage is blocked, hazardous conditions such as a gas explosion or a fire can be prevented.

### BRIEF DESCRIPTION OF THE DRAWINGS

FIG. 1 is a block diagram schematically illustrating an internal structure of an indoor gas detecting apparatus.

FIG. 2 is a flowchart illustrating the operation of a controller of an indoor gas detecting apparatus.

FIG. 3 is a block diagram schematically illustrating the structure of an indoor air purification system using an indoor gas detecting apparatus of the present invention.

### DETAILED DESCRIPTION

Hereinafter, exemplary embodiments of the present invention will be described in detail with reference to the accompanying drawings.

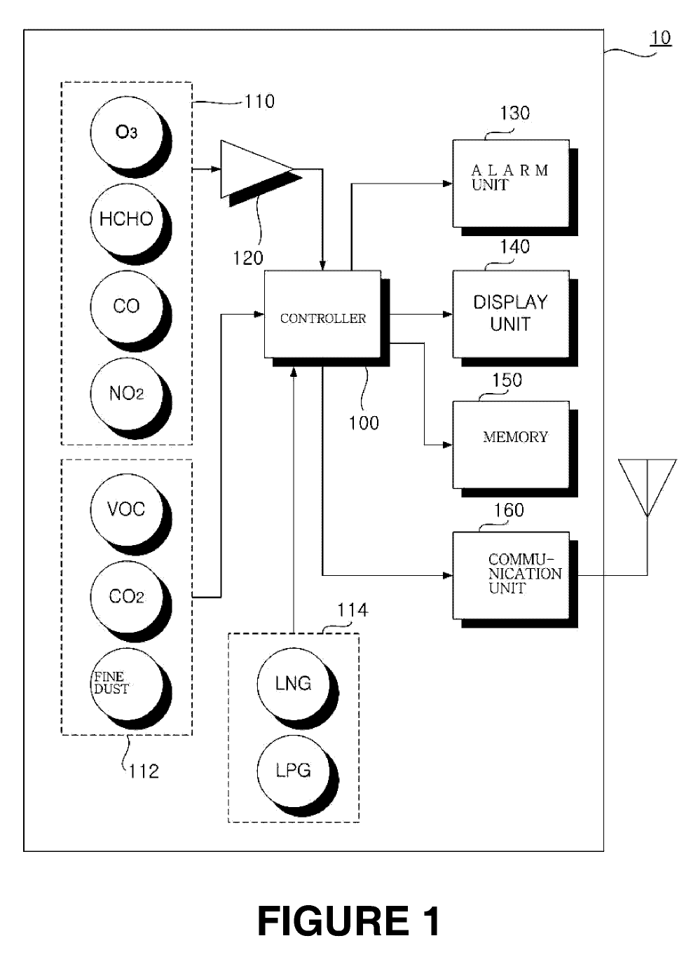

FIG. 1 is a block diagram schematically illustrating an internal structure of an indoor gas detecting apparatus 10. Referring to FIG. 1, the indoor gas detecting apparatus 10 includes a controller 100 that controls overall operations, a first gas sensor unit 110, a second gas sensor unit 112, a third gas sensor unit 114, a signal amplifier 120, an alarm unit 130, a display unit 140, a memory 150, and a communication unit 160. The indoor gas detecting apparatus 10 having the aforementioned structure may display information on the amount of gases contained in indoor air detected by using the respective gas sensor units 110, 112, and 114. The indoor gas detecting apparatus 10 may operate the alarm unit 130 if the gas amount exceeds a permission level. The indoor gas detecting apparatus 10 may transmit an operation signal to an external automatic gas blocking apparatus or an air purification apparatus through the communication unit 160. The aforementioned elements will now be described in detail.

The gas sensor unit 110 includes one or more sensors selected from the group consisting of ozone O₃ sensor, a formaldehyde (HCHO) sensor, a carbon monoxide (CO) sensor, and a nitrogen dioxide (NO₂) sensor. These sensors may be electrochemical type gas sensors. If the first gas sensor unit 110 is composed of electrochemical type gas sensors, the signal amplifier 120 is connected to the output end of the first gas sensor unit 110. The signal amplifier 120 may be an operational amplifier.

The second gas sensor unit 112 may include one or more sensors selected from the group consisting of a volatile organic compound (VOC) sensor, a carbon dioxide (CO₂) sensor, and a fine dust sensor. The VOC sensor may be an electrochemical gas sensor or a semiconductor gas sensor. The CO₂ sensor and the fine dust sensor may be optical gas sensors. In particular, the fine dust sensor includes a light emitting element and a light receiving element so as to detect dust amount by sensing light when the light is emitted from the light emitting element, is then transmitted through the air, and is then received to the light receiving element.

The third gas sensor unit 114 includes sensors that sense a liquefied natural gas (LNG) or a liquid petroleum gas (LPG) which are supplied to a gas range or a gas boiler.

The alarm unit 130 includes a buzzer or a light emitting diode (LED) which outputs a sound signal of a specific frequency. The alarm unit 130 operates in response to the operation signal of the controller 100. If the amount of a noxious gas contained in the air exceeds a predetermined permission level, the controller 100 transmits the operation signal to the alarm unit 130 so as to operate the alarm unit 130. Thus, a user is informed of a hazardous state.

The display unit 140 is composed of a liquid crystal display (LCD) or a plasma display panel (PDP). The display unit 140 displays a data signal transmitted from the controller 100. The controller 100 transmits the amount of gas contained in the air or the hazardous state to the display unit 140 so that this information is displayed on the display unit 140.

The memory 150 stores or manages information on the permission level of each gas predetermined by the user. The memory 150 stores information on the amount of gas for a specific time period. The controller 100 detects the amount of gas contained in the air and determines whether the detected gas amount exceeds the permission level stored in the memory 150.

The communication unit 160 is a communication module that can transmit/receive data to/from an external apparatus. The communication unit 160 may be not only a wired communication module but also a wireless communication module. If the gas amount exceeds the permission level, the controller 100 sends a relevant signal to the external apparatus by using the communication unit 160.

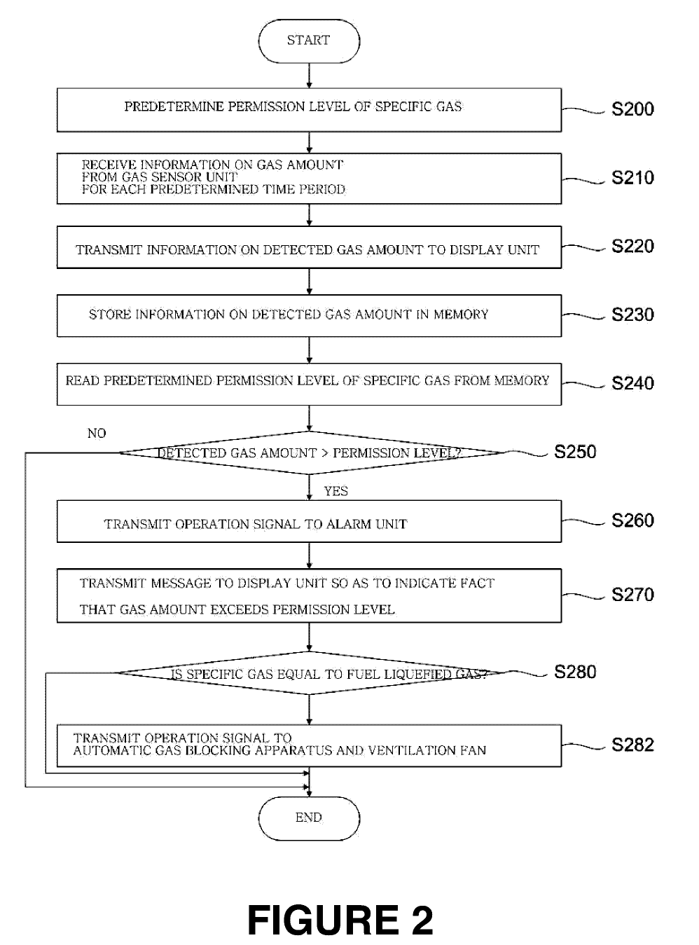

FIG. 2 is a flowchart illustrating the operation of the controller 100 of the indoor gas detecting apparatus 10. Now, the operation of the controller 100 of the indoor gas detecting apparatus 10 of the present invention will be described in detail with reference to FIG. 2.

First, permission levels of noxious gases and fine dusts are predetermined by the user, and information on the predetermined permission levels is stored in and managed by a memory (step 200). In this step, the user may directly input the permission levels of respective gases so that the input permission levels are stored in the memory. Alternatively, when the user presses a specific setting key in a condition where a fresh indoor air is provided, gas amounts of the respective gases contained in the indoor air may be detected so that the detected gas amounts are determined to be the permission levels of the gases and are then stored in the memory.

Meanwhile, for each predetermined time period, a signal indicating the gas amount detected by the respective sensors included in the first, second, and third sensor units of an indoor gas detecting apparatus is received (step 210). Information on the detected gas amount is transmitted to a display unit so as to display the information (step 220). The information is stored in and managed by the memory (step 230).

Next, the predetermined permission level of a specific gas is read from the memory (step 240). If the detected gas amount exceeds the predetermined permission level (step 250), an operation signal is transmitted to an alarm unit (step 260). A message is transmitted to the display unit so that the display unit displays the fact that the detected gas amount exceeds the permission level of the gas (step 270).

If the detected gas amount exceeds the permission level of the gas, the operation signal is transmitted to an external air purification apparatus through a communication unit so as to operate the air purification apparatus. In particular, if the gas amount detected by the third gas sensing unit composed of LNG gas sensors or LPG gas sensors exceeds the permission level (step 280), the operation signal is transmitted to an external automatic gas blocking apparatus or an external ventilation fan through the communication unit. As a result, gas leakage is prevented and the ventilation fan operates so that the indoor air is exhausted to the outside.

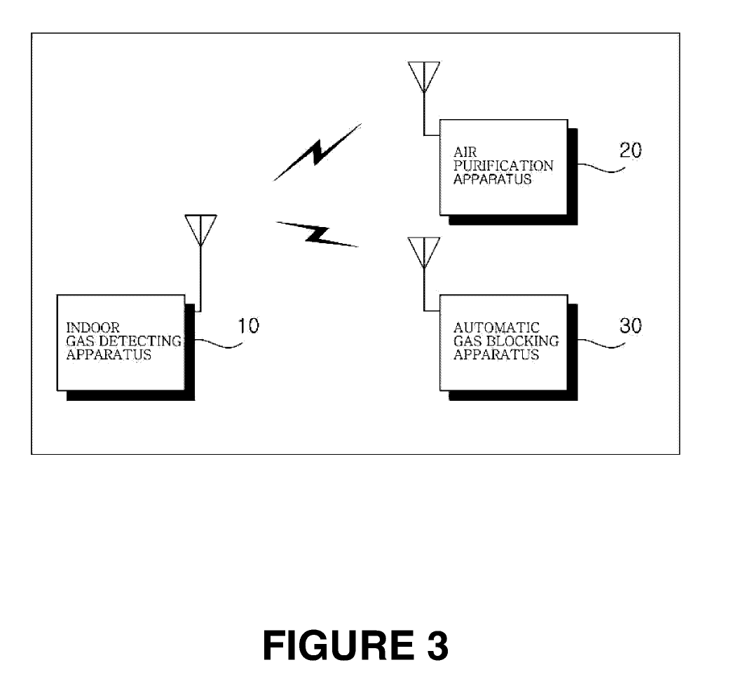

FIG. 3 is a block diagram schematically illustrating the structure of an indoor air purification system using the indoor gas detecting apparatus of the present invention. Referring to FIG. 3, the indoor air purification system includes an indoor gas detecting apparatus 10, an air purification apparatus 20, and an automatic gas blocking apparatus 30. The respective apparatuses include communication modules that can communicate with one another. The communication modules included in the respective apparatuses may be RF modules that support indoor wireless communication for home or indoor use or may be wireless communication modules such as a Bluetooth communication module, a Zigbee communication module, and an ultra-wideband (UWB) communication module.

The indoor gas detecting apparatus 10 detects the amount of gas contained in the indoor air. If the detected gas amount exceeds the permission level, the indoor gas detecting apparatus 10 transmits the operation signal to the air purification apparatus 20 or the automatic gas blocking apparatus 30 according to a gas type. The air purification apparatus 20 operates in response to the operation signal transmitted from the indoor gas detecting apparatus 10 so as to purify the indoor air. The automatic gas blocking apparatus 30 also operates in response to the operation signal received from the indoor gas detecting apparatus 10. Thus, the automatic gas blocking apparatus 30 turns off a valve of a gas range or a gas boiler and operates a ventilation fan for air ventilation.

While the present invention has been particularly shown and described with reference to exemplary embodiments thereof, it will be understood by those skilled in the art that various changes in form and details may be made therein without departing from the spirit and scope of the invention as defined by the appended claims. For example, in the embodiments of the present invention, the kinds and types of gas sensors included in a gas sensor unit may be modified to improve regulation or capability depending on an indoor environment. Thus, all differences related to the modification and application of the invention will be construed as being included in the scope of the present invention.

An indoor gas detecting apparatus of the present invention can be widely used in a home network system or an industrial factory automation system for industrial use.

1. An indoor gas detecting apparatus comprising:
a gas sensor unit composed of one or more gas sensors;
a controller that controls overall operations;
a display unit that displays data received from the controller;
an alarm unit that operates in response to a control signal of the controller;
a memory that stores and manages information sensed by the gas sensor unit or a predetermined permission level for each gas; and
a communication unit that transmits data transmitted from the controller to an external apparatus or transmits data received from the external apparatus to the controller,
wherein the controller receives a signal for each gas from the gas sensor unit, detects a gas amount by using the received signal, and, if the detected gas amount exceeds the predetermined permission level, displays the gas amount to the display unit or transmits the gas amount to the external apparatus through the communication unit.

2. The indoor gas detecting apparatus of claim 1, wherein the gas sensor unit is composed of:
a first gas sensor unit that includes one or more sensors selected from the group consisting of ozone sensor, a formaldehyde sensor, a carbon monoxide sensor, and a nitrogen dioxide sensor; and
a second gas sensor unit that includes one or more sensors selected from the group consisting of a volatile organic compound sensor, a fine dust sensor, and a carbon dioxide sensor.

3. The indoor gas detecting apparatus of claim 2,
wherein the first gas sensor is composed of electrochemical gas sensors, and
wherein the indoor gas detecting apparatus further comprises a signal amplifier interposed between the first gas sensor unit and the controller, and the signal amplifier amplifies a signal output from the first gas sensor and transmits the amplified signal to the controller.

4. The indoor gas detecting apparatus of claim 1,
wherein the gas sensor unit includes a fuel liquefied gas sensor that senses a fuel liquefied gas, and
wherein the controller detects a gas concentration input from the fuel liquefied gas sensor, and, if the detected gas concentration exceeds the predetermined permission level, displays the gas amount to the display unit or transmits an operation signal to an external automatic gas blocking apparatus and/or a ventilation fan through the communication unit.

5. An indoor air purification system comprising:
an indoor gas detecting apparatus which has one or more gas sensors and a communication module transmitting/receiving data to/from an external apparatus, detects concentration of a specific gas contained in indoor air, and transmits relevant information to the external apparatus; and
an air purification apparatus which has a communication module transmitting/receiving data to/from the indoor gas detecting apparatus and operates in response to an operation request signal transmitted from the indoor gas detecting apparatus.

6. The indoor air purification system of claim 5, further comprising an automatic gas blocking apparatus, wherein the automatic gas blocking apparatus has a communication module transmitting/receiving data to/from the indoor gas detecting apparatus and operates in response to the operation request signal transmitted from the indoor gas detecting apparatus.
